(19) United States
(12) Patent Application Publication
(10) Pub. No.: US 2016/0098773 A1
(43) Pub. Date: Apr. 7, 2016

(54) INFUSING PRODUCT POPULARITY INSIGHTS INTO SEARCH RESULTS FOR PRODUCT RESEARCH QUERIES

(71) Applicant: Yahoo! Inc., Sunnyvale, CA (US)

(72) Inventor: Aravindan Raghuveer, Sunnyvale, CA (US)

(21) Appl. No.: 14/505,337

(22) Filed: Oct. 2, 2014

(51) Int. Cl. G06Q 30/06

(52) U.S. Cl. CPC G06Q 30/0625

(57) ABSTRACT

In one embodiment, a search query may be received. It may be ascertained that the search query pertains to a particular product category. A set of products that pertain to the particular product category may be identified, where the set of products are top selling products in the particular product category. Information pertaining to each product in the set of products may be provided.

### BACKGROUND OF THE INVENTION

The disclosed embodiments relate generally to computer-implemented methods and apparatus for providing information pertaining to popular products in response to product search queries.

As the internet has become ubiquitous, many times, a search engine is the first stop for a user attempting to find information on the internet about a particular subject. Search engines are provided by a number of entities and search capabilities are embedded in many web sites. For instance, many web sites provide search applications that enable users to search the content of the web sites, as well as web sites across the Internet.

Typically, a search engine returns a list of search results in response to a search query. The search engine may also generate revenue from advertisements provided with or as part of the search results. Unfortunately, search results are often voluminous and time-consuming to navigate.

### SUMMARY OF THE INVENTION

In one embodiment, a search query may be received. It may be ascertained that the search query pertains to a particular product category. A set of products that pertain to the particular product category may be identified, where the set of products are top selling products in the particular product category. Information pertaining to each product in the set of products may be provided.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2A is a process flow diagram illustrating an example method of processing a search query in accordance with various embodiments.

FIG. 2B is a process flow diagram illustrating an example method of selecting advertisements to be presented for a product in accordance with various embodiments.

FIG. 3 is a diagram illustrating an example graphical user interface that may be presented in response to a search query in accordance with various embodiments.

FIG. 4 is a schematic diagram illustrating an example embodiment of a network in which various embodiments may be implemented.

FIG. 5 is a schematic diagram illustrating an example client device in which various embodiments may be implemented.

FIG. 6 is a schematic diagram illustrating an example computer system in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In recent years, the Internet has been a main source of information for millions of users. These users rely on the Internet to search for information of interest to them. One conventional way for users to search for information is to initiate a search query through a search service's web page. Typically, a user can enter a query including one or more search term(s) into an input box on the search web page and then initiate a search based on such entered search term(s). In response to the query, the search service typically returns an ordered list of search result documents.

A Uniform Resource Locator (URL) may identify a location at which a document is located. The document may be located on a particular web site, as well as a specific web page on the web site. For instance, a first URL may identify a location of a web page at which a document is located, while a second URL may identify a location of a web site at which the document can be located.

When a search service returns a list of search result documents in response to a user's search query, the user must then determine which search results to view. The user may view numerous documents in his or her search for the desired information. Even after spending a significant amount of time reviewing documents, the user may still have difficulty finding the information they seek. Accordingly, the search process may be a frustrating experience for the user.

In accordance with various embodiments, a user may submit a search query to perform product research. In response, product popularity insights may be provided to the user. Such product popularity insights may be provided independently, or may be provided in conjunction with search results.

Example System

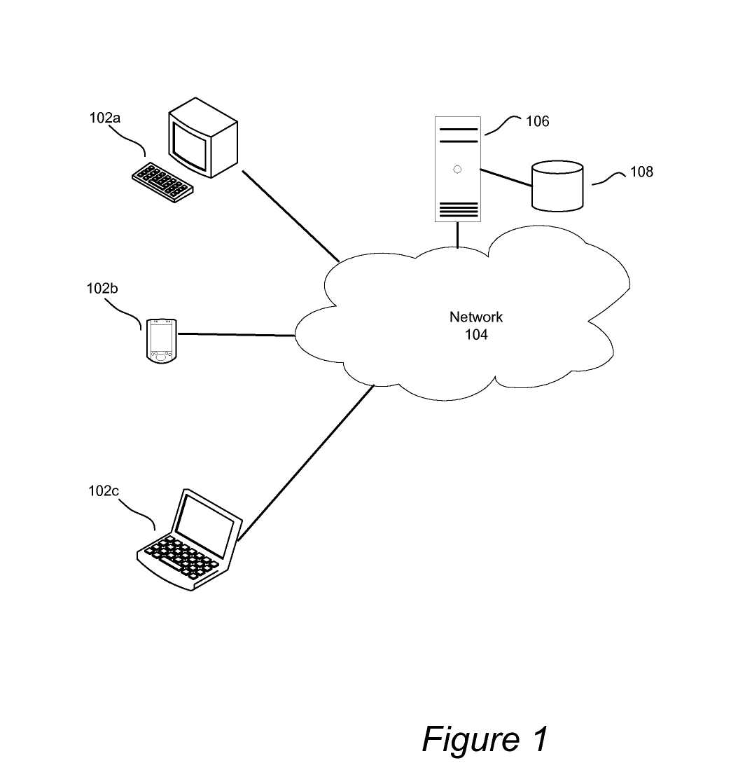

FIG. 1 is a diagram illustrating an example system in which embodiments of the invention may be implemented. As shown in FIG. 1, the system may include one or more servers 106 associated with a web site such as a social networking web site. Examples of social networking web sites include Yahoo, Facebook, Tumblr, LinkedIn, Flickr, and Meme. The server(s) 106 may enable the web site to provide a variety of services to its users. More particularly, users of the web site may communicate with other individuals via a medium such as electronic mail. In addition, users of the web site may access other services such as maintain public user profiles, upload files (e.g., photographs, videos), etc.

The server(s) 106 may include a search server and a web server. As shown, a plurality of clients 102a, 102b, 102c may access a search application (i.e., search service), for example, on the search server via network 104 and/or access a web service, for example, on the web server.

In addition, the server(s) 106 may include an electronic mail server that enables electronic mail messages to be routed between individuals. The plurality of clients 102a, 102b, 102c may access an electronic mail application to generate, transmit, or receive electronic mail messages from other individuals. An electronic mail application may be installed on the server(s) 106 or the clients 102a, 102b, 102c.

The network 104 may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The invention may also be practiced in a wide variety of network environments (represented by network 104) including, for example, TCP/IP-based networks, telecommunications networks, wireless networks, etc. In addition, the computer program instructions with which embodiments of the invention may be implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is related to a search query including one or more search terms. The search terms may be entered by a user in any manner. For example, a graphical user interface may present an input feature to the client (so the user can enter a query including one or more search term(s). More particularly, the graphical user interface may present an input box (i.e., search query section) into which a user may type a query including any number of search terms or portion thereof. In some embodiments, suggested search queries (i.e., search suggestions) may be provided. The user may then select one of the suggested search queries to submit to the search application via the graphical user interface.

The search query may then be executed via a search application with respect to one or more data sources. The data sources may include local data sources (e.g., on the client) and/or data sources that are remotely located via the network 104. In response to the search query, the search application may identify and present information, which may include documents that are most relevant to the user's search query.

In addition, where a search query pertains to product research, a product popularity module may ascertain a particular product category to which the search query pertains. Information pertaining to a set of top selling products (i.e., popular products) in the particular product category may be obtained and provided in response to the search query. The information may be provided independently, or in conjunction with search results.

The product popularity module may be implemented separately or in combination with the search application. The search application and product popularity module may each be installed and executed via the server(s) 106 such as the search server and/or web server. The search application and product popularity module may be implemented on any number of servers although a single search server 106 is illustrated for clarity. In some embodiments, the search application may be installed and executed on the client device.

Embodiments disclosed herein may be implemented via the search server 106 and/or other server(s) and/or the clients 102a, 102b, 102c. For example, various features may be implemented via a web browser and/or application on the clients 102a, 102b, and 102c. The disclosed embodiments may be implemented via software and/or hardware.

The search server 106 (or servers) may have access to one or more query logs into which search information is retained. For example, the query logs may be retained in one or more memories 108 that are coupled to the server(s) 106. Each time a user performs a search on one or more search terms, information regarding such search may be retained in the query logs. For instance, the user's search request may contain any number of parameters, such as user or browser identity and the search terms, which may be retained in the query logs. Additional information related to the search, such as a timestamp, may also be retained in the query logs along with the search request parameters. When results are presented to the user based on the entered search terms, parameters from such search results may also be retained in the query logs. For example, an identity of the specific search results (e.g., URLs), such as the web sites, the order in which the search results are presented, whether each search result is a sponsored or algorithmic search result, the owner (e.g., web site) of each search result, and/or whether each search result is selected (i.e., clicked on) by the user (if any), may be retained in the query logs.

In addition, the memories 108 may store one or more user logs (e.g., user databases) that retain user information. This user information or a portion thereof may be referred to as a user profile. More particularly, the user profile may include public information that is available in a public profile and/or private information. Furthermore, the user profile may include information that has been submitted by the user and/or information that has been deduced or automatically collected by the system (e.g., based upon user action(s)). The user information retained in the user logs may include personal information such as demographic information (e.g., age and/or gender) and/or geographic information (e.g., Global Positioning System (GPS) location, Internet Protocol (IP) address, country region/state, city, and/or zip code), which may include or indicate the user's residence address, work address, and/or current location. In addition, the user information may indicate interests of the user, products or services purchased by the user, properties (e.g., categories) of information that the user commonly accesses on the Internet, and/or a profession of the user. A user may be identified in the user logs by a user ID (e.g., user account ID), information in a user cookie, etc. The user logs may be retained in one or more memories.

A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

In addition, a product mining module of the server(s) 106 may mine and store information pertaining to products in the memories 108. More particularly, the server(s) 106 may gather information such as product popularity insights for a plurality of products for each one of a plurality of categories and store this gathered information in the memories 108. The information such as metadata and/or data may be mined from sources including, but not limited to, electronic mail messages received by the server(s) 106 and/or top selling product lists on the Internet. For example, product purchase information in electronic mail messages received or transmitted via the server(s) 106 may be processed to extract information such as brand (e.g., manufacturer), model, sales price, and/or date or purchase. Such electronic mail messages may include sales receipts received by users, as well as messages such as purchase orders transmitted by users to sellers (e.g., retailers). As another example, a top selling product list published on the Internet may be processed to extract information such as brand, model, sales price (e.g., average sales price, highest sales price, and/or lowest sales price), and/or date (or date range) that is pertinent to a top selling product list. Electronic mail messages (e.g., including product receipts), top selling product lists, and/or information extracted or derived therefrom may be stored in the memories 108. In this manner, information pertinent to relevant and recent purchase decisions of other customers may be mined and aggregated to benefit an end user in his or her search mission.

The server(s) 106 may also analyze the gathered information for the products in each of the plurality of categories and store results of this analysis in the memories 108. The results of the analysis may identify a set of top selling products for each one of the plurality of categories, as well as include product information for each top selling product. More particularly, the product information may identify the top selling product, as well as include sales information pertaining to the top selling product. A top selling product may be identified by a brand (e.g., manufacturer) of the product and a model of the product. The sales information pertaining to a top selling product may include purchase price information associated with the product such as an average purchase price, lowest purchase price, or highest purchase price. In addition, the sales information may indicate a popularity of the top selling product (e.g., in relation to other top selling products in the same product category). The sales information may also include popularity statistics such as number of units of the top selling product purchased, percentage of products in the category purchased being the top selling product, and/or percentage of sales of the top selling product to individuals having particular user characteristics. Thus, popularity statistics may be category agnostic or category specific. The sales information may be associated with a date and/or date range. Accordingly, product popularity insights may be mined and stored for subsequent retrieval.

A product may have slightly different names across different retailers. As a result, alternate product names for products may be identified such that product information for the product is aggregated. Thus, entity name disambiguation for product synonyms may be applied to ensure that product information for alternate product names is aggregated and accurate.

For each product or top selling product in a given category, a list of keywords relevant to the product may be generated and stored. In some embodiments, a separate list of keywords may be maintained for each alternate product name. The list of keywords may include terms in the product name, as well as other pertinent terms. Such a list may be used for advertisement selection or bidding.

In some embodiments, the product information may include that associated with products purchased via online auctions. For example, the product information may be gathered for products identified as “new with tags,” “NWT,” “new in box,” “NIB,” “new,” “new without tags,” “NWOT,” “and/or “used.” In this manner, product information may be gathered, filtered, and further categorized according to the condition of the products that are purchased.

The gathering and analysis of information for various products may be performed periodically (e.g., on a daily or hourly basis). In some embodiments, the gathering and analysis of the information for various products may be performed off-line. To eliminate noise, data may be discarded or ignored if there fails to be at least a minimum threshold number of purchases for a particular product or product category.

The number of products in a set of top selling products may be a pre-defined number or may be established dynamically via a suitable algorithm. The top selling products for a particular category of products may be identified on a periodic basis. For example, the top selling products may be identified on a weekly basis.

The disclosed embodiments enable search queries that pertain to product research to be identified. In response to a search query that pertains to product research in a particular product category, information pertaining to a set of top selling products in the particular product category may be provided. More particularly, the server(s) 106 may provide the information or hypertext link(s) thereto via the web site (e.g., via display on a web page of the web site), via electronic mail, Short Message Service (SMS), via a mobile device (e.g., text message), or via another medium such as digital television, which may be connected to the Internet.

The information pertaining to a set of top selling products that is provided may include product information (e.g., sales information) for each top selling product such as that described above. In addition, the information that is provided may also include one or more advertisements or hypertext links that provide access to one or more advertisements. More particularly, the information may be provided in conjunction with search results provided by the search engine. In one embodiment, the product information for a top selling product may include a hypertext link to a single advertisement for the top selling product. In another embodiment, the product information for a top selling product may include a hypertext link to a web page that includes a plurality of advertisements from different retailers that sell the top selling product.

An advertisement pertaining to a top selling product in the set of top selling products may be selected based, at least in part, upon product information for the top selling product. As described above, the product information pertaining to a top selling product may include sales information such as purchase price information. For example, purchase price information may include lowest purchase price or highest purchase price. The sales information may also indicate a popularity of the top selling product (e.g., in relation to other top selling products in the same product category). Moreover, the sales information may also include popularity statistics such as number of units of the top selling product purchased, percentage of products in the category purchased being the top selling product, and/or percentage of sales of the top selling product to individuals having particular user characteristics.

As discussed above, user profiles may be accessed by the search engine to identify the most appropriate search results to present in response to a search query received from a user. In some embodiments, the product popularity module may also access user profiles. For example, the product information presented for each top selling product may include statistics indicating the percentage of sales of the product to similarly situated users (e.g., users having one or more identical or similar user characteristics to the user submitting the search query). In other embodiments, the product popularity module may not access user profiles such that the product information that is gathered for each top selling product is agnostic to the identity of the users purchasing the product.

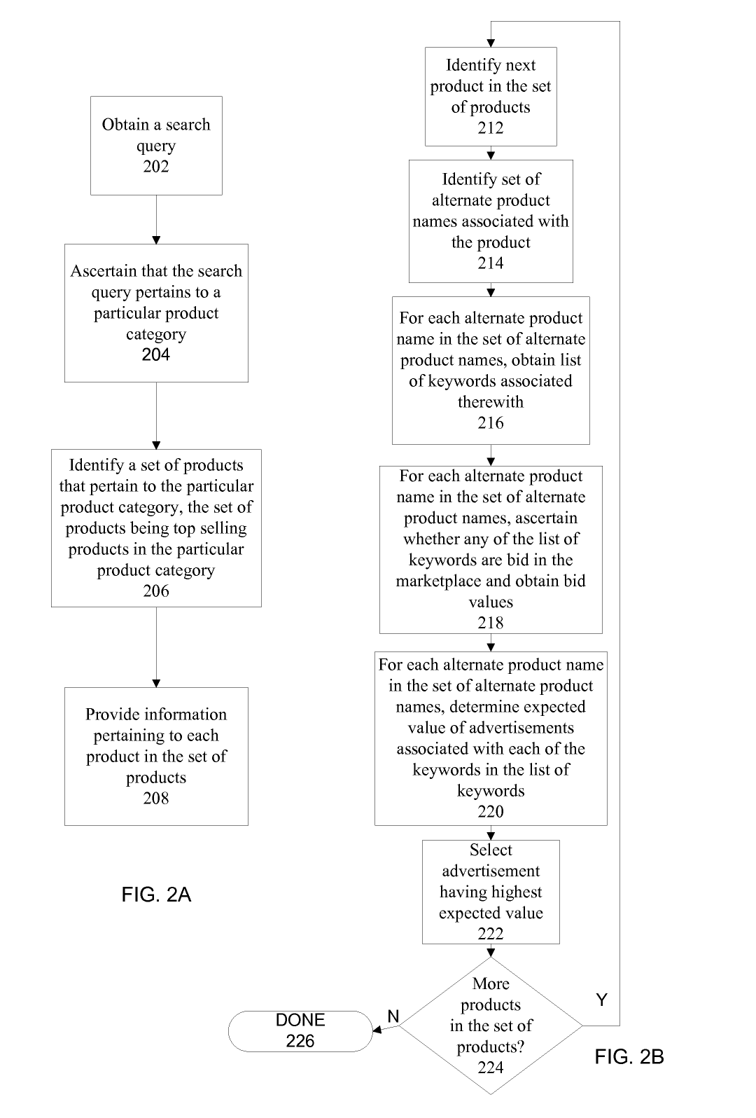

FIG. 2A is a process flow diagram illustrating an example method of processing a search query in accordance with various embodiments. A search query may be obtained at 202. For example, the search query may be received via a graphical user interface. The search query may be processed by a search engine to obtain search results. In addition, it may be determined whether the search query pertains to product research.

A product popularity module may be triggered if the search query pertains to product research. In accordance with various embodiments, the product popularity module may be triggered if the search query includes a product category name (e.g., camera) and a product research signifier or modifier such as “best,” “top,” “popular,” or “cheap.” Upon determining that the search query pertains to product research, the particular product category may be ascertained. Thus, it may be ascertained that the search query pertains to a particular product category at 204.

A set of products that pertain to the particular product category may be identified at 206, where the set of products are top selling products in the particular product category. The set of products may be identified from product sale information. As discussed above, the product sale information may be extracted from electronic mail messages including product sale receipts and/or best seller lists on the Internet.

The product sale information may pertain to new products and/or used products (e.g., according to the search query). In addition, such product sale information may include that associated with products purchased via online auctions. For example, product sale information may be filtered for products identified as “new with tags,” “NWT,” “new in box,” “NIB,” “new,” “new without tags,” “NWOT,” “and/or “used.”

Information pertaining to each product in the set of products may be provided at 208. For example, a product display module may provide the information for display via a graphical user interface. More particularly, the information for a product may indicate a manufacturer of the product, a model of the product, purchase price information associated with the product, and/or a level of popularity of the product. The information may also pertain to a pertinent date or date range. For example, the information that is provided may indicate that out of 100 cameras sold in the past week, 60 were Nikon D80. In this manner, popularity insights for the past week or month may be provided in response to a product research query.

In addition, the information for a product may include or otherwise provide access to one or more advertisements for a product. More particularly, the information for a product in the set of products may include one or more advertisements for the product. Alternatively, the information for a product in the set of products may include a hypertext link that provides access to one or more advertisements for the product. For example, the hypertext link may provide access to a web page including a single advertisement for the product. As another example, the hypertext link may provide access to a web page including a plurality of advertisements for the product (e.g., where the advertisements correspond to different retailers of the product). A method of selecting advertisement(s) for a particular product will be described in further detail below with reference to FIG. 2B.

By providing advertisements or hypertext link(s) to advertisements for top-selling products, it is possible to provide advertisements that have a high probability of maximizing revenue. In addition, it is possible to present advertisements for products that were not identified in the search query. Since the user has indicated an interest or intent to make a product purchase, there is also a high likelihood of a click through by the user. Furthermore, since the user has not yet selected a product or retailer from which to purchase a product, the disclosed embodiments may present advertisements early in the product research process.

In accordance with various embodiments, a set of search results associated with the query may be obtained. The information pertaining to each product in the set of products may be provided in conjunction with the set of search results. Advertisements presented in conjunction with the set of search results may include algorithmic advertisements, as well as those presented via the product popularity module.

As described above, once a set of top selling products has been identified, information including advertisements may be presented at 208 for each of the top selling products. FIG. 2B is a process flow diagram illustrating an example method of selecting an advertisement to be presented for a product in accordance with various embodiments. A next product in the set of products may be identified at 212. A set of one or more alternate product names associated with the product may be identified at 214. For each alternate product name in the set of alternate product names, a list of keywords associated therewith may be obtained at 216. For each alternate product name in the set of alternate product names, it may be ascertained whether any of the keywords in the associated list of keywords is bid in the marketplace and corresponding bid values may be obtained at 218. For each alternate product name in the set of alternate product names, an expected value of advertisements associated with each of the keywords in the list of keywords may be determined at 220. More particularly, to calculate an expected value for an advertisement, the bid value of a keyword may be multiplied by an expected click through rate (CTR) for the advertisement. At least one advertisement having the highest expected value may be selected at 222. If any further products remain in the set of top selling products at 224, the process may continue at 212. Alternatively, if no further products remain, the process may end at 226.

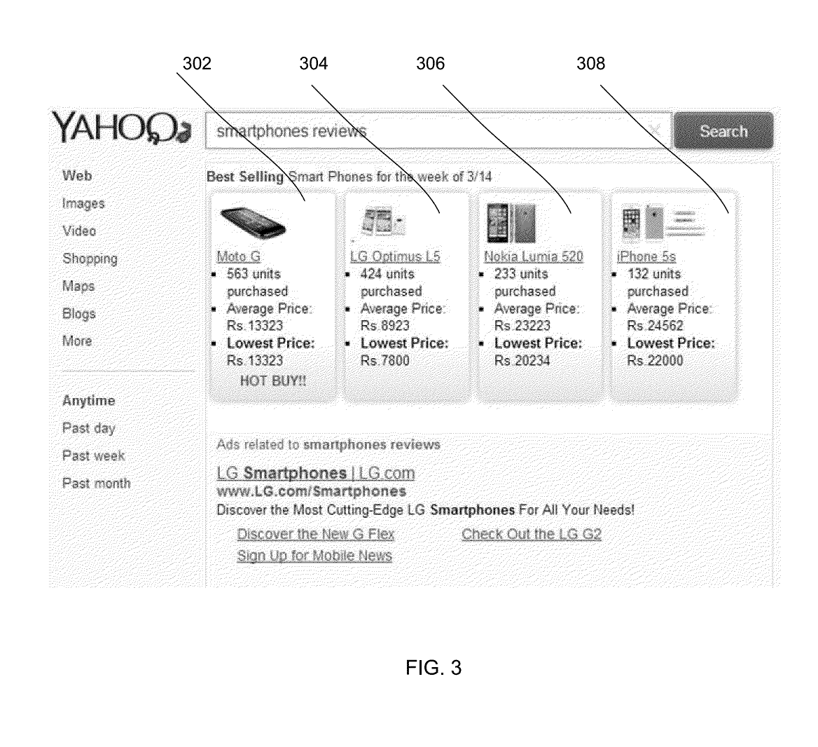

FIG. 3 is a diagram illustrating an example graphical user interface that may be presented in response to a search query in accordance with various embodiments. As shown in FIG. 3, information pertaining to a set of top selling products may be presented in an upper region of a web page. In this example, the set of top selling products includes four products. However, this example is merely illustrative. Therefore, a set of top selling products may contain more or fewer products.

The product information that is presented for the set of top selling products may correspond to a period of time such as a week. In this example, the set of top selling products represents the best-selling smart phones for the week of Mar. 14, 2014. Thus, the set of top selling products in this example pertains to the product category “smart phones.”

The product information for each of the top selling products may be represented in a separate, corresponding segment of the web page. In this example, product information for each of four different top selling products is presented in a different, corresponding rectangular segment of the web page. More particularly, the product information for “Moto G” is represented in a first segment 302, the product information for “LG Optimus L5” is presented in a second segment 304, the product information for “Nokia Lumia 520” is presented in a third segment 306, and the product information for “iPhone 5s” is presented in a fourth segment 308.

The product information for each top selling product may include sales information that has been garnered from source(s) such as electronic mail product receipts and/or top selling product lists published on the Internet. In this example, the product information for each of the top selling products indicates a number of units purchased, an average price, and a lowest price.

The product information for each top selling product may also include a hypertext link that provides access to a web page including one or more advertisements for the corresponding top selling product. In this example, the product identifier (e.g., product name) is a hypertext link. Upon clicking on the hypertext link, the user may be presented a web page including one or more advertisements for the corresponding product.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

### Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

Network Architecture

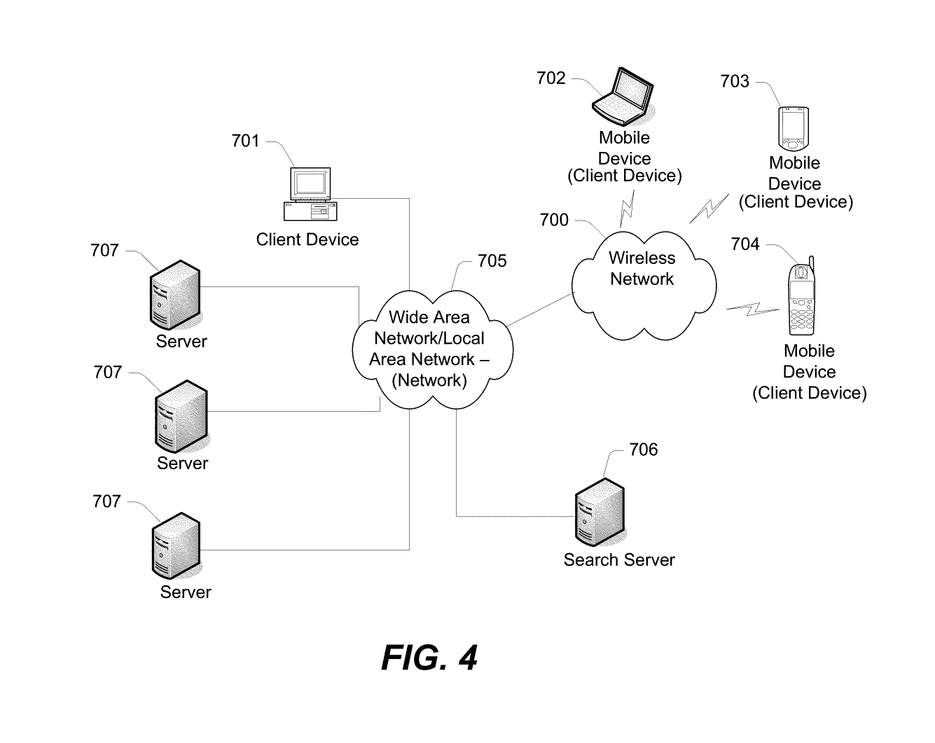

The disclosed embodiments may be implemented in any of a wide variety of computing contexts. FIG. 4 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 4, for example, includes a variety of networks, such as a LAN/WAN 705 and wireless network 700, a variety of devices, such as client devices 701-704, and a variety of servers such as content server(s) 707 and search server 706. The servers may also include an ad server (not shown). As shown in this example, the client devices 701-704 may include one or more mobile devices 702, 703, 704. Client device(s) 701-704 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The disclosed embodiments may be implemented in some centralized manner. This is represented in FIG. 4 by server(s) 707, which may correspond to multiple distributed devices and data store(s). The server(s) 707 and/or corresponding data store(s) may store user account data, user information, and/or content.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

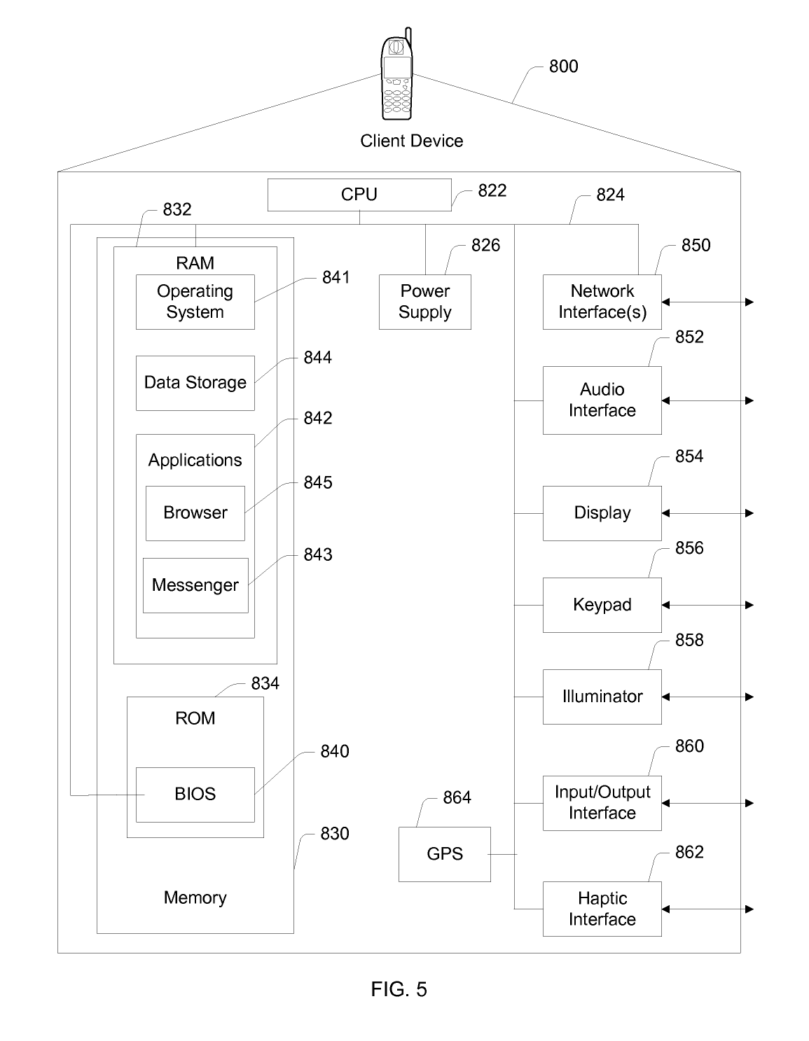

FIG. 5 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 800 may include one or more central processing units (CPUs) 822, which may be coupled via connection 824 to a power supply 826 and a memory 830. The memory 830 may include random access memory (RAM) 832 and read only memory (ROM) 834. The ROM 834 may include a basic input/output system (BIOS) 840.

The RAM 832 may include an operating system 841. More particularly, a client device may include or may execute a variety of operating systems, including a personal computer operating system, such as a Windows, iOS or Linux, or a mobile operating system, such as iOS, Android, or Windows Mobile, or the like. The client device 800 may also include or may execute a variety of possible applications 842 (shown in RAM 832), such as a client software application such as messenger 843, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 844. A client device may also include or execute an application such as a browser 845 to perform a variety of possible tasks, such as browsing, searching, playing various forms of content, including locally stored or streamed video, or games (such as fantasy sports leagues).

The client device 800 may send or receive signals via one or more interface(s). As shown in this example, the client device 800 may include one or more network interfaces 850. The client device 800 may include an audio interface 852. In addition, the client device 800 may include a display 854 and an illuminator 858. The client device 800 may further include an Input/Output interface 860, as well as a Haptic Interface 862 supporting tactile feedback technology.

The client device 800 may transmit and detect patterns, images, or signals such as infra-red signals via the interface(s). Such patterns, images, or signals may uniquely identify a particular object (e.g., individual or item). For example, the client device 800 may transmit an infra-red blink pattern identifying a particular object, as well as detect an infra-red blink pattern.

The client device 800 may vary in terms of capabilities or features. Claimed subject matter is intended to cover a wide range of potential variations. For example, a cell phone may include a keypad such 856 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 864 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

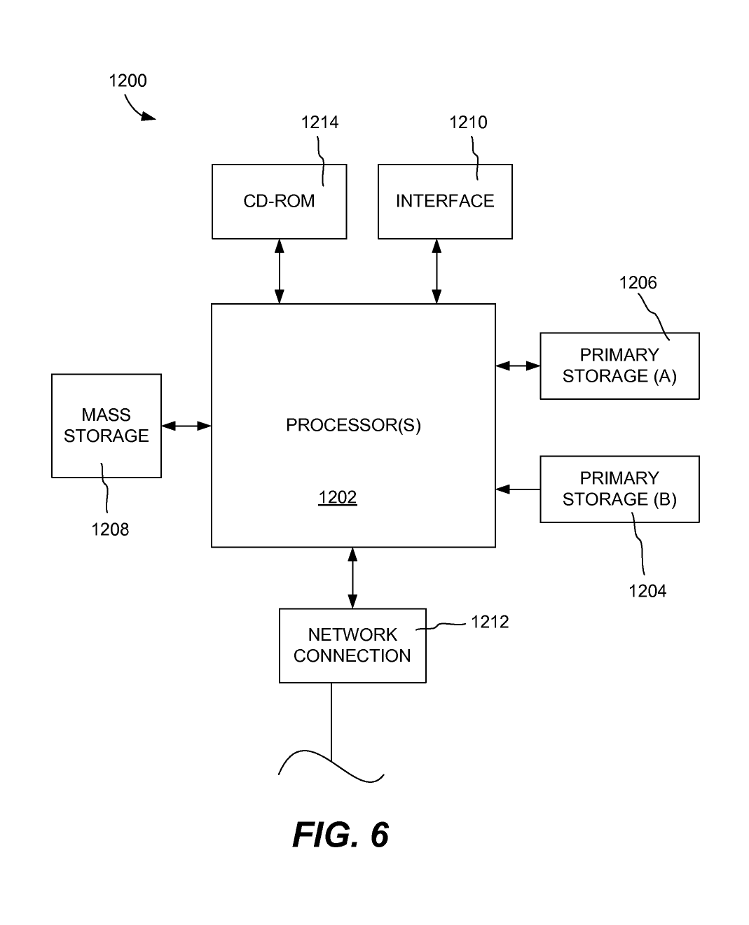

FIG. 6 illustrates a typical computer system that, when appropriately configured or designed, can serve as a system via which various embodiments may be implemented. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. Moreover, a system implementing various embodiments may be a portable device, such as a laptop or cell phone. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
obtaining a search query;
ascertaining that the search query pertains to a particular product category;
identifying a set of products that pertain to the particular product category, the set of products being top selling products in the particular product category; and
providing information pertaining to each product in the set of products.

2. The method as recited in claim 1, further comprising:
obtaining a set of search results associated with the search query;
providing the set of search results;
wherein the information pertaining to each product in the set of products is provided in conjunction with the set of search results.

3. The method as recited in claim 1, wherein the information for a product in the set of products comprises one or more advertisements for the product.

4. The method as recited in claim 1, wherein the information for a product in the set of products comprises a hypertext link, the hypertext link providing access to one or more advertisements for the product.

5. The method as recited in claim 1, wherein the information for a product in the set of products comprises a hypertext link to a web page including a plurality of advertisements for the product.

6. The method as recited in claim 1, wherein identifying a set of products that pertain to the particular product category comprises:
identifying the set of products from product sale information.

7. The method as recited in claim 6, wherein at least a portion of the product sale information has been extracted from electronic mail messages or best seller lists.

8. The method as recited in claim 1, wherein the information for each product in the set of products indicates at least one of a brand of the product, a model of the product, purchase price information associated with the product, or a level of popularity of the product.

9. A non-transitory computer-readable storage medium storing thereon computer-readable instructions, comprising:
instructions for obtaining a search query;
instructions for ascertaining that the search query pertains to a particular product category;
instructions for identifying a set of products that pertain to the particular product category, the set of products being top selling products in the particular product category; and
instructions for providing information pertaining to each product in the set of products.

10. The non-transitory computer-readable storage medium as recited in claim 9, wherein the information for a product in the set of products comprises one or more advertisements for the product.

11. The non-transitory computer-readable storage medium as recited in claim 10, wherein the advertisements for the product are selected based, at least in part, upon product information associated with the product.

12. The non-transitory computer-readable storage medium as recited in claim 9, wherein the information for a product in the set of products comprises a hypertext link, the hypertext link providing access to one or more advertisements for the product.

13. The non-transitory computer-readable storage medium as recited in claim 9, wherein identifying a set of products that pertain to the particular product category comprises:
identifying the set of products from product sale information, wherein at least a portion of the product sale information has been extracted from electronic mail messages or best seller lists.

14. The non-transitory computer-readable storage medium as recited in claim 9, wherein the information for each product in the set of products indicates at least one of a brand of the product, a model of the product, purchase price information associated with the product, or a level of popularity of the product.

15. A system comprising a processor and non-transient memory with program logic for execution on the processor, the program logic comprising:
a product popularity module configured to
ascertain that a search query pertains to a particular product category;
identify a set of top selling products that pertain to the particular product category; and
provide information pertaining to each product in the set of products.

16. The system as recited in claim 15, wherein the information for a product in the set of products comprises one or more advertisements for the product.

17. The system as recited in claim 15, wherein the information for a product in the set of products comprises a hypertext link, the hypertext link providing access to one or more advertisements for the product.

18. The system as recited in claim 15, wherein the information for a product in the set of products comprises a hypertext link to a web page including a plurality of advertisements for the product.

19. The system as recited in claim 15, wherein the product popularity module is further configured to identify the set of products from product sale information, wherein at least a portion of the product sale information has been extracted from electronic mail messages or best seller lists.

20. The system as recited in claim 15, further comprising:
a product mining module configured to extract product sale information from at least one of electronic mail messages or best seller lists;
wherein the product popularity module is configured to identify the set of top selling products that pertain to the particular product category from the product sale information.
